SEQUENCE LISTING (18 sequences)

SEQ ID NO: 1 - DNA, 1341 bp, Bacillus subtillis
  misc_feature: levansucrase gene coding sequence
gcgtttgcgaaagaaacgaaccaaaagccatataaggaaacatacggcatttcccatattacacgccatgatatgctgcaaatccctgaacagcaaaaaaatgaaaaatatcaagttcctgaattcgattcgtccacaattaaaaatatctcttctgcaaaaggcctggacgtttgggacagctggccattacaaaacgctgacggcactgtcgcaaactatcacggctaccacatcgtctttgcattagccggagatcctaaaaatgcggatgacacatcgatttacatgttctatcaaaaagtcggcgaaacttctattgacagctggaaaaacgctggccgcgtctttaaagacagcgacaaattcgatgcaaatgattctatcctaaaagaccaaacacaagaatggtcaggttcagccacatttacatctgacggaaaaatccgtttattctacactgatttctccggtaaacattacggcaaacaaacactgacaactgcacaagttaacgtatcagcatcagacagctctttgaacatcaacggtgtagaggattataaatcaatctttgacggtgacggaaaaacgtatcaaaatgtacagcagttcatcgatgaaggcaactacagctcaggcgacaaccatacgctgagagatcctcactacgtagaagataaaggccacaaatacttagtatttgaagcaaacactggaactgaagatggctaccaaggcgaagaatctttatttaacaaagcatactatggcaaaagcacatcattcttccgtcaagaaagtcaaaaacttctgcaaagcgataaaaaacgcacggctgagttagcaaacggcgctctcggtatgattgagctaaacgatgattacacactgaaaaaagtgatgaaaccgctgattgcatctaacacagtaacagatgaaattgaacgcgcgaacgtctttaaaatgaacggcaaatggtacctgttcactgactcccgcggatcaaaaatgacgattgacggcattacgtctaacgatatttacatgcttggttatgtttctaattctttaactggcccatacaagccgctgaacaaaactggccttgtgttaaaaatggatcttgatcctaacgatgtaacctttacttactcacacttcgctgtacctcaagcgaaaggaaacaatgtcgtgattacaagctatatgacaaacagaggattctacgcagacaaacaatcaacgtttgcgccaagcttcctgctgaacatcaaaggcaagaaaacatctgttgtcaaagacagcatccttgaacaaggacaattaacagttaacaaa

SEQ ID NO: 2 - DNA, 1341 bp, Bacillus subtillis
  misc_feature: modified levansucrase gene coding sequence
gcgtttgcgaaagaaacgaaccaaaagccatataaggaaacatacggcatttcccatattacacgccatgatatgctgcaaatccctgaacagcaaaaaaatgaaaaatatcaagttcctgagttcgattcgtccacaattaaaaatatctcttctgcaaagggcctggacgtttgggacagctggccattacaaaacgctgacggcactgtcgcaaactatcacggctaccacatcgtctttgcattagccggagatcctaaaaatgcggatgacacatcgatttacatgttctatcaaaaagtcggcgaaacttctattgacagctggaaaaacgctggccgcgtctttaaagacagcgacaaattcgatgcaaatgattctatcctaaaagaccaaacacaagaatggtcaggttcagccacatttacatctgacggaaaaatccgtttattctacactgatttctccggtaaacattacggcaaacaaacactgacaactgcacaagttaacgtatcagcatcagacagctctttgaacatcaacggtgtagaggattataaatcaatctttgacggtgacggaaaaacgtatcaaaatgtacagcagttcatcgatgaaggcaactacagctcaggcgacaaccatacgctgagagatcctcactacgtagaagataaaggccacaaatacttagtatttgaagcaaacactggaactgaagatggctaccaaggcgaagaatctttatttaacaaagcatactatggcaaaagcacatcattcttccgtcaagaaagtcaaaaacttctgcaaagcgataaaaaacgcacggctgagttagcaaacggcgctctcggtatgattgagctaaacgatgattacacactgaaaaaagtgatgaaaccgctgattgcatctaacacagtaacagatgaaattgaacgcgcgaacgtctttaaaatgaacggcaaatggtatctgttcactgactcccgcggatcaaaaatgacgattgacggcattacgtctaacgatatttacatgcttggttatgtttctaattctttaactggcccatacaagccgctgaacaaaactggccttgtgttaaaaatggatcttgatcctaacgatgtaacctttacttactcacacttcgctgtacctcaagcgaaaggaaacaatgtcgtgattacaagctatatgacaaacagaggattctacgcagacaaacaatcaacgtttgcgccatctttcctgctgaacatcaaaggcaagaaaacatctgttgtcaaagacagcatccttgaacaaggacaattaacagttaacaaa

SEQ ID NO: 3 - DNA, 558 bp, Mus muscularis
  misc_feature: Dihydrofolate reductase gene coding sequence
gttcgaccattgaactgcatcgtcgccgtgtcccaaaatatggggattggcaagaacggagacctaccctggcctccgctcaggaacgagttcaagtacttccaaagaatgaccacaacctcttcagtggaaggtaaacagaatctggtgattatgggtaggaaaacctggttctccattcctgagaagaatcgacctttaaaggacagaattaatatagttctcagtagagaactcaaagaaccaccacgaggagctcattttcttgccaaaagtttggatgatgccttaagacttattgaacaaccggaattggcaagtaaagtagacatggtttggatagtcggaggcagttctgtttaccaggaagccatgaatcaaccaggccaccttagactctttgtgacaaggatcatgcaggaatttgaaagtgacacgtttttcccagaaattgatttggggaaatataaacttctcccagaatacccaggcgtcctctctgaggtccaggaggaaaaaggcatcaagtataagtttgaagtctacgagaagaaagac

SEQ ID NO: 4 - DNA, 111 bp, Homo sapiens
  misc_feature: Shine-Dalgarno sequence
agatctcgatcccgcgaaattaatacgactcactataggggaattgtgagcggataacaattcccctctagaaataattttgtttaactttaagaaggagatatacatatg

SEQ ID NO: 5 - DNA, 111 bp, Homo sapiens
  misc_feature: mutated, non-operational Shine-Dalgarno sequence
agatctcgatcccgcgaaattaatacgactcactataggggaattgtgagcggataacaattcccctctagaaataattttgtttaactttatcttcctgatatacatatg

SEQ ID NO: 6 - DNA, 25 bp, Artificial
  Synthetic Oligonucleotide
catatgtgttaactgagtaggatcc

SEQ ID NO: 7 - DNA, 279 bp, Esherichia coli
  misc_feature: Coding sequence of amino acid residues 329-421 of the periplasmic protein TolA
aacaatggcgcatcaggggccgatatcaataactatgccgggcagattaaatctgctatcgaaagtaagttctatgacgcatcgtcctatgcaggcaaaacctgtacgctgcgcataaaactggcacccgatggtatgttactggatatcaaacctgaaggtggcgatcccgcactttgtcaggctgcgttggcagcagctaaacttgcgaagatcccgaaaccaccaagccaggcagtatatgaagtgttcaaaaacgcgccattggacttcaaaccg

SEQ ID NO: 8 - DNA, 20 bp, Artificial
  Synthetic Oligonucleotide
tatttatctttttaatgtct

SEQ ID NO: 9 - DNA, 1356 bp, Bacillus subtillis
  misc_feature: EcoRI Modified levansucrose gene coding sequence with stop codon
gaattcgcgtttgcgaaagaaacgaaccaaaagccatataaggaaacatacggcatttcccatattacacgccatgatatgctgcaaatccctgaacagcaaaaaaatgaaaaatatcaagttcctgagttcgattcgtccacaattaaaaatatctcttctgcaaagggcctggacgtttgggacagctggccattacaaaacgctgacggcactgtcgcaaactatcacggctaccacatcgtctttgcattagccggagatcctaaaaatgcggatgacacatcgatttacatgttctatcaaaaagtcggcgaaacttctattgacagctggaaaaacgctggccgcgtctttaaagacagcgacaaattcgatgcaaatgattctatcctaaaagaccaaacacaagaatggtcaggttcagccacatttacatctgacggaaaaatccgtttattctacactgatttctccggtaaacattacggcaaacaaacactgacaactgcacaagttaacgtatcagcatcagacagctctttgaacatcaacggtgtagaggattataaatcaatctttgacggtgacggaaaaacgtatcaaaatgtacagcagttcatcgatgaaggcaactacagctcaggcgacaaccatacgctgagagatcctcactacgtagaagataaaggccacaaatacttagtatttgaagcaaacactggaactgaagatggctaccaaggcgaagaatctttatttaacaaagcatactatggcaaaagcacatcattcttccgtcaagaaagtcaaaaacttctgcaaagcgataaaaaacgcacggctgagttagcaaacggcgctctcggtatgattgagctaaacgatgattacacactgaaaaaagtgatgaaaccgctgattgcatctaacacagtaacagatgaaattgaacgcgcgaacgtctttaaaatgaacggcaaatggtatctgttcactgactcccgcggatcaaaaatgacgattgacggcattacgtctaacgatatttacatgcttggttatgtttctaattctttaactggcccatacaagccgctgaacaaaactggccttgtgttaaaaatggatcttgatcctaacgatgtaacctttacttactcacacttcgctgtacctcaagcgaaaggaaacaatgtcgtgattacaagctatatgacaaacagaggattctacgcagacaaacaatcaacgtttgcgccatctttcctgctgaacatcaaaggcaagaaaacatctgttgtcaaagacagcatccttgaacaaggacaattaacagttaacaaataactcgag

SEQ ID NO: 10 - DNA, 573 bp, Mus muscularis
  misc_feature: EcoRI modified dihydrofolate reductase gene coding sequence with stop codon
gaattcgttcgaccattgaactgcatcgtcgccgtgtcccaaaatatggggattggcaagaacggagacctaccctggcctccgctcaggaacgagttcaagtacttccaaagaatgaccacaacctcttcagtggaaggtaaacagaatctggtgattatgggtaggaaaacctggttctccattcctgagaagaatcgacctttaaaggacagaattaatatagttctcagtagagaactcaaagaaccaccacgaggagctcattttcttgccaaaagtttggatgatgccttaagacttattgaacaaccggaattggcaagtaaagtagacatggtttggatagtcggaggcagttctgtttaccaggaagccatgaatcaaccaggccaccttagactctttgtgacaaggatcatgcaggaatttgaaagtgacacgtttttcccagaaattgatttggggaaatataaacttctcccagaatacccaggcgtcctctctgaggtccaggaggaaaaaggcatcaagtataagtttgaagtctacgagaagaaagactaactcgag

SEQ ID NO: 11 - DNA, 309 bp, Escherichia coli
  misc_feature: ccdB toxin gene coding sequence
tctgcccggcagtttaaggtttacacctataaaagagagagccgttatcgtctgtttgtggatgtacagagtgatattattgacacgccggggcgacggatggtgatccccctggccagtgcacgtctgctgtcagataaagtctcccgtgaactttacccggtggtgcatatcggggatgaaagctggcgcatgatgaccaccgatatggccagtgtgccggtctccgttatcggggaagaagtggctgatctcagccaccgcgaaaatgacatcaaaaacgccattaacctgatgttctggggaata

SEQ ID NO: 12 - DNA, 324 bp, Escherichia coli
  misc_feature: EcoRI modified ccdB toxin gene coding sequence with stop codon
gaattctctgcccggcagtttaaggtttacacctataaaagagagagccgttatcgtctgtttgtggatgtacagagtgatattattgacacgccggggcgacggatggtgatccccctggccagtgcacgtctgctgtcagataaagtctcccgtgaactttacccggtggtgcatatcggggatgaaagctggcgcatgatgaccaccgatatggccagtgtgccggtctccgttatcggggaagaagtggctgatctcagccaccgcgaaaatgacatcaaaaacgccattaacctgatgttctggggaatataactcgag

SEQ ID NO: 13 - DNA, 1791 bp, Bacillus subtillis
  misc_feature: EcoRI modified levansucrose gene coding sequence with stop codon
agatctcgatcccgcgaaattaatacgactcactataggggaattgtgagcggataacaattcccctctagaaataattttgtttaactttatcttcctgatatacatatgtgttaactgagtaggatccaacaatggcgcatcaggggccgatatcaataactatgccgggcagattaaatctgctatcgaaagtaagttctatgacgcatcgtcctatgcaggcaaaacctgtacgctgcgcataaaactggcacccgatggtatgttactggatatcaaacctgaaggtggcgatcccgcactttgtcaggctgcgttggcagcagctaaacttgcgaagatcccgaaaccaccaagccaggcagtatatgaagtgttcaaaaacgcgccattggacttcaaaccgctgcagtatttatctttttaatgtctgaattcgcgtttgcgaaagaaacgaaccaaaagccatataaggaaacatacggcatttcccatattacacgccatgatatgctgcaaatccctgaacagcaaaaaaatgaaaaatatcaagttcctgagttcgattcgtccacaattaaaaatatctcttctgcaaagggcctggacgtttgggacagctggccattacaaaacgctgacggcactgtcgcaaactatcacggctaccacatcgtctttgcattagccggagatcctaaaaatgcggatgacacatcgatttacatgttctatcaaaaagtcggcgaaacttctattgacagctggaaaaacgctggccgcgtctttaaagacagcgacaaattcgatgcaaatgattctatcctaaaagaccaaacacaagaatggtcaggttcagccacatttacatctgacggaaaaatccgtttattctacactgatttctccggtaaacattacggcaaacaaacactgacaactgcacaagttaacgtatcagcatcagacagctctttgaacatcaacggtgtagaggattataaatcaatctttgacggtgacggaaaaacgtatcaaaatgtacagcagttcatcgatgaaggcaactacagctcaggcgacaaccatacgctgagagatcctcactacgtagaagataaaggccacaaatacttagtatttgaagcaaacactggaactgaagatggctaccaaggcgaagaatctttatttaacaaagcatactatggcaaaagcacatcattcttccgtcaagaaagtcaaaaacttctgcaaagcgataaaaaacgcacggctgagttagcaaacggcgctctcggtatgattgagctaaacgatgattacacactgaaaaaagtgatgaaaccgctgattgcatctaacacagtaacagatgaaattgaacgcgcgaacgtctttaaaatgaacggcaaatggtatctgttcactgactcccgcggatcaaaaatgacgattgacggcattacgtctaacgatatttacatgcttggttatgtttctaattctttaactggcccatacaagccgctgaacaaaactggccttgtgttaaaaatggatcttgatcctaacgatgtaacctttacttactcacacttcgctgtacctcaagcgaaaggaaacaatgtcgtgattacaagctatatgacaaacagaggattctacgcagacaaacaatcaacgtttgcgccatctttcctgctgaacatcaaaggcaagaaaacatctgttgtcaaagacagcatccttgaacaaggacaattaacagttaacaaataactcgag

SEQ ID NO: 14 - DNA, 759 bp, Escherichia coli
  misc_feature: EcoRI modified ccdB toxin gene coding sequence with stop codon
agatctcgatcccgcgaaattaatacgactcactataggggaattgtgagcggataacaattcccctctagaaataattttgtttaactttatcttcctgatatacatatgtgttaactgagtaggatccaacaatggcgcatcaggggccgatatcaataactatgccgggcagattaaatctgctatcgaaagtaagttctatgacgcatcgtcctatgcaggcaaaacctgtacgctgcgcataaaactggcacccgatggtatgttactggatatcaaacctgaaggtggcgatcccgcactttgtcaggctgcgttggcagcagctaaacttgcgaagatcccgaaaccaccaagccaggcagtatatgaagtgttcaaaaacgcgccattggacttcaaaccgctgcagtatttatctttttaatgtctgaattctctgcccggcagtttaaggtttacacctataaaagagagagccgttatcgtctgtttgtggatgtacagagtgatattattgacacgccggggcgacggatggtgatccccctggccagtgcacgtctgctgtcagataaagtctcccgtgaactttacccggtggtgcatatcggggatgaaagctggcgcatgatgaccaccgatatggccagtgtgccggtctccgttatcggggaagaagtggctgatctcagccaccgcgaaaatgacatcaaaaacgccattaacctgatgttctggggaatataactcgag

SEQ ID NO: 15 - DNA, 1008 bp, Mus muscularis
  misc_feature: EcoRI modified dihydrofolate reductase gene coding sequence with stop codon
agatctcgatcccgcgaaattaatacgactcactataggggaattgtgagcggataacaattcccctctagaaataattttgtttaactttaagaaggagatatacatatgtgttaactgagtaggatccaacaatggcgcatcaggggccgatatcaataactatgccgggcagattaaatctgctatcgaaagtaagttctatgacgcatcgtcctatgcaggcaaaacctgtacgctgcgcataaaactggcacccgatggtatgttactggatatcaaacctgaaggtggcgatcccgcactttgtcaggctgcgttggcagcagctaaacttgcgaagatcccgaaaccaccaagccaggcagtatatgaagtgttcaaaaacgcgccattggacttcaaaccgctgcagtatttatctttttaatgtctgaattcgttcgaccattgaactgcatcgtcgccgtgtcccaaaatatggggattggcaagaacggagacctaccctggcctccgctcaggaacgagttcaagtacttccaaagaatgaccacaacctcttcagtggaaggtaaacagaatctggtgattatgggtaggaaaacctggttctccattcctgagaagaatcgacctttaaaggacagaattaatatagttctcagtagagaactcaaagaaccaccacgaggagctcattttcttgccaaaagtttggatgatgccttaagacttattgaacaaccggaattggcaagtaaagtagacatggtttggatagtcggaggcagttctgtttaccaggaagccatgaatcaaccaggccaccttagactctttgtgacaaggatcatgcaggaatttgaaagtgacacgtttttcccagaaattgatttggggaaatataaacttctcccagaatacccaggcgtcctctctgaggtccaggaggaaaaaggcatcaagtataagtttgaagtctacgagaagaaagactaactcgag

SEQ ID NO: 16 - DNA, 40 bp, Artificial
  Synthetic Oligonucleotide
catatgttaattaaatcaggcctctggtttaaacggatcc

SEQ ID NO: 17 - DNA, 40 bp, Artificial
  Synthetic Oligonucleotide
catatgtccctaggtggaggcctctgggccggccggatcc

SEQ ID NO: 18 - DNA, 5277 bp, Artificial
  pET28 vector sequence, including frame shift stuffer of SEQ ID NO 6, encoding a 6-HIS C-terminal tag
tggcgaatgggacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgattagggtgatggttcacgtagtgggccatcgccctgatagacggtttttcgccctttgacgttggagtccacgttctttaatagtggactcttgttccaaactggaacaacactcaaccctatctcggtctattcttttgatttataagggattttgccgatttcggcctattggttaaaaaatgagctgatttaacaaaaatttaacgcgaattttaacaaaatattaacgtttacaatttcaggtggcacttttcggggaaatgtgcgcggaacccctatttgtttatttttctaaatacattcaaatatgtatccgctcatgaattaattcttagaaaaactcatcgagcatcaaatgaaactgcaatttattcatatcaggattatcaataccatatttttgaaaaagccgtttctgtaatgaaggagaaaactcaccgaggcagttccataggatggcaagatcctggtatcggtctgcgattccgactcgtccaacatcaatacaacctattaatttcccctcgtcaaaaataaggttatcaagtgagaaatcaccatgagtgacgactgaatccggtgagaatggcaaaagtttatgcatttctttccagacttgttcaacaggccagccattacgctcgtcatcaaaatcactcgcatcaaccaaaccgttattcattcgtgattgcgcctgagcgagacgaaatacgcgatcgctgttaaaaggacaattacaaacaggaatcgaatgcaaccggcgcaggaacactgccagcgcatcaacaatattttcacctgaatcaggatattcttctaatacctggaatgctgttttcccggggatcgcagtggtgagtaaccatgcatcatcaggagtacggataaaatgcttgatggtcggaagaggcataaattccgtcagccagtttagtctgaccatctcatctgtaacatcattggcaacgctacctttgccatgtttcagaaacaactctggcgcatcgggcttcccatacaatcgatagattgtcgcacctgattgcccgacattatcgcgagcccatttatacccatataaatcagcatccatgttggaatttaatcgcggcctagagcaagacgtttcccgttgaatatggctcataacaccccttgtattactgtttatgtaagcagacagttttattgttcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcctgatgcggtattttctccttacgcatctgtgcggtatttcacaccgcatatatggtgcactctcagtacaatctgctctgatgccgcatagttaagccagtatacactccgctatcgctacgtgactgggtcatggctgcgccccgacacccgccaacacccgctgacgcgccctgacgggcttgtctgctcccggcatccgcttacagacaagctgtgaccgtctccgggagctgcatgtgtcagaggttttcaccgtcatcaccgaaacgcgcgaggcagctgcggtaaagctcatcagcgtggtcgtgaagcgattcacagatgtctgcctgttcatccgcgtccagctcgttgagtttctccagaagcgttaatgtctggcttctgataaagcgggccatgttaagggcggttttttcctgtttggtcactgatgcctccgtgtaagggggatttctgttcatgggggtaatgataccgatgaaacgagagaggatgctcacgatacgggttactgatgatgaacatgcccggttactggaacgttgtgagggtaaacaactggcggtatggatgcggcgggaccagagaaaaatcactcagggtcaatgccagcgcttcgttaatacagatgtaggtgttccacagggtagccagcagcatcctgcgatgcagatccggaacataatggtgcagggcgctgacttccgcgtttccagactttacgaaacacggaaaccgaagaccattcatgttgttgctcaggtcgcagacgttttgcagcagcagtcgcttcacgttcgctcgcgtatcggtgattcattctgctaaccagtaaggcaaccccgccagcctagccgggtcctcaacgacaggagcacgatcatgcgcacccgtggggccgccatgccggcgataatggcctgcttctcgccgaaacgtttggtggcgggaccagtgacgaaggcttgagcgagggcgtgcaagattccgaataccgcaagcgacaggccgatcatcgtcgcgctccagcgaaagcggtcctcgccgaaaatgacccagagcgctgccggcacctgtcctacgagttgcatgataaagaagacagtcataagtgcggcgacgatagtcatgccccgcgcccaccggaaggagctgactgggttgaaggctctcaagggcatcggtcgagatcccggtgcctaatgagtgagctaacttacattaattgcgttgcgctcactgcccgctttccagtcgggaaacctgtcgtgccagctgcattaatgaatcggccaacgcgcggggagaggcggtttgcgtattgggcgccagggtggtttttcttttcaccagtgagacgggcaacagctgattgcccttcaccgcctggccctgagagagttgcagcaagcggtccacgctggtttgccccagcaggcgaaaatcctgtttgatggtggttaacggcgggatataacatgagctgtcttcggtatcgtcgtatcccactaccgagatatccgcaccaacgcgcagcccggactcggtaatggcgcgcattgcgcccagcgccatctgatcgttggcaaccagcatcgcagtgggaacgatgccctcattcagcatttgcatggtttgttgaaaaccggacatggcactccagtcgccttcccgttccgctatcggctgaatttgattgcgagtgagatatttatgccagccagccagacgcagacgcgccgagacagaacttaatgggcccgctaacagcgcgatttgctggtgacccaatgcgaccagatgctccacgcccagtcgcgtaccgtcttcatgggagaaaataatactgttgatgggtgtctggtcagagacatcaagaaataacgccggaacattagtgcaggcagcttccacagcaatggcatcctggtcatccagcggatagttaatgatcagcccactgacgcgttgcgcgagaagattgtgcaccgccgctttacaggcttcgacgccgcttcgttctaccatcgacaccaccacgctggcacccagttgatcggcgcgagatttaatcgccgcgacaatttgcgacggcgcgtgcagggccagactggaggtggcaacgccaatcagcaacgactgtttgcccgccagttgttgtgccacgcggttgggaatgtaattcagctccgccatcgccgcttccactttttcccgcgttttcgcagaaacgtggctggcctggttcaccacgcgggaaacggtctgataagagacaccggcatactctgcgacatcgtataacgttactggtttcacattcaccaccctgaattgactctcttccgggcgctatcatgccataccgcgaaaggttttgcgccattcgatggtgtccgggatctcgacgctctcccttatgcgactcctgcattaggaagcagcccagtagtaggttgaggccgttgagcaccgccgccgcaaggaatggtgcatgcaaggagatggcgcccaacagtcccccggccacggggcctgccaccatacccacgccgaaacaagcgctcatgagcccgaagtggcgagcccgatcttccccatcggtgatgtcggcgatataggcgccagcaaccgcacctgtggcgccggtgatgccggccacgatgcgtccggcgtagaggatcgagatctcgatcccgcgaaattaatacgactcactataggggaattgtgagcggataacaattcccctctagaaataattttgtttaactttaagaaggagatatacatatgtgttaactgagtaggatcccatcaccatcaccatcactaactcgagcaccaccaccaccaccactgagatccggctgctaacaaagcccgaaaggaagctgagttggctgctgccaccgctgagcaataactagcataaccccttggggcctctaaacgggtcttgaggggttttttgctgaaaggaggaactatatccggat

(19) United States
(12) Patent Application Publication
(10) Pub. No.: US 2012/0329673 A1
(43) Pub. Date: Dec. 27, 2012

(54) VECTORS AND METHODS FOR SELECTING OPEN READING FRAMES

(76) Inventor: Geoffrey S. Waldo, Santa Fe, NM (US)

(21) Appl. No.: 12/516,256

(22) PCT Filed: Oct. 24, 2007
(86) PCT No.: PCT/US07/22769

§ 371 Date: Feb. 8, 2010

(30) Foreign Application Priority Data
Oct. 24, 2006 (US) 60854179

(51) Int. Cl. C40B 30/06; C40B 99/00

(52) U.S. Cl. 506/10; 506/43

(57) ABSTRACT

The invention provides vectors and methods designed for screening large random DNA fragment libraries for the presence of open reading frames that are free of both internal ribosome binding sites (IRBS) and stop codons. The invention overcomes the principal limitation of known ORF-selector systems, namely the potential for ORF-induced folding interference of the downstream fused reporter, by not fusing the reporter to the ORF, but rather by providing a mechanism for coupled translation of an unfused downstream reporter.

### STATEMENT AS TO RIGHTS TO INVENTIONS MADE UNDER FEDERALLY SPONSORED RESEARCH OR DEVELOPMENT

This invention was made with government support under Contract No. W-7405-ENG-36 awarded by the United States Department of Energy to The Regents of The University of California. The government has certain rights in this invention.

### BACKGROUND OF THE INVENTION

Directed evolution involves the creation of large libraries of DNAs encoding protein variants, followed by screening the expressed protein variants for desired properties such as improved folding or function. In the absence of specific functional assays for a protein of interest, folding and solubility can be tested by folding reporters (C-terminal fusions of reporter proteins with an easily-measured function) or solubility reporters (split protein complementation systems, e.g., Split-GFP system described in United States Patent Application No. US20050221343-A1).

Certain artifacts regularly occur at significant frequencies in large libraries, and compromise screening efficiency. These include frame shifts, stop codons and internal translation initiation sites. Pre-screening libraries to eliminate clones with such undesirable artifacts substantially reduces the amount of screening that is required in subsequent analyses, and greatly facilitates the effective screening of large libraries in functional genomics, functional proteomics and directed evolution studies. A number of approaches for identifying and eliminating frame-shifted DNA fragments from large libraries have been developed, including expression of the protein encoded by the DNA fragment in fusion with an N-terminal reporter, such as green fluorescent protein (GFP) (Waldo et al., 1999) and chloramphenicol acetyltransferase (Maxwell et al., 1999), in order to provide an observable phenotype for selecting clones with in-frame ORFs.

Various selection systems have been developed to overcome the limitations of using simple fusion proteins to select ORFs. In one approach, the DNA fragment is positioned between two reporters, both of which are required to give an observable phenotype. For example, Szostak and co-workers employed dual N- and C-terminal epitope tags to pre-screen mRNA display libraries (Cho et al., 2000, J. Mol. Biol, 297:309-319). In contrast, the plasmid-based in vivo systems pLAB (Seehaus et al., 1992, Gene, 114:235-237), ORFTRAP (Daugelat and Jacobs, 1999, Protein Sci., 8:644-653) and pSALect (Lutz et al., 2002, Protein Eng., 15:1026-1030) require an in-frame, correctly oriented gene of interest to render a host cell antibiotic resistant.

In the pSALect approach of Lutz et al, 2002, supra, a first reporter (Tat signal sequence) directs the post-translational export of the fusion protein to the periplasm (Yahr and Wickner, 2001, EMBO J., 20:2472-2479; Palmer and Berks, 2003, Microbiology, 149:547-556), and a second reporter (β-lactamase) requires periplasmic export for function. As a result, only completely translated, in-frame fusion proteins (peIB-X-βlac) can be exported to confer ampicillin resistance. However, in this system, X can cause misfolding of βlac, resulting in the failure of otherwise full-length genes to be selected. Further, not all otherwise useful well-folded proteins can be exported to the periplasmic space via the sec pathway, which requires unfolding of the protein prior to transit. This can result in bias. Lutz et al. attempted to minimize this problem by sandwiching the fragment X between a split intein as peIB-intein(N)-X-intein(C)-βlac. Here, if X has no stop codon, then the intein excises itself and X, leading to peIB-βlac, which is exported and confers resistance to ampicillin (Gerth et al., 2004, Protein Engineering, Design & Selection 17: 595-602). Unfortunately, folding interference between X and the intein domains can cause the intein domains to misfold, resulting in the failure of the inteins to excise X, thus resulting in aborted transport. Therefore, this ORF-selector can still result in bias towards well-folded proteins X. Further, stop codons near the beginning of X and internal ribosome binding sites near the end of X can result in a split intein, which can spontaneously complement, resulting in splicing of peIB-βlac, and export. This results in false positives from internal ribosome binding site artifacts.

The degree of bias introduced by the known ORF-selector systems is difficult if not impossible to quantify. It would be desirable to eliminate all such bias in order to guard against the risk that functional variants will be eliminated unnecessarily in the course of pre-selection for reading frame. What is therefore needed is a method to select for ORFs with no stop codons and no IRBS. Ideally, such a method would not operate by fusing the selectable marker with the ORF, since fusions can be affected by folding interference. The properties of the mRNA rather than the protein should be assessed in the selection process.

### SUMMARY OF THE INVENTION

The invention provides vectors and methods designed for screening large random DNA fragment libraries for the presence of open reading frames that are free of both internal ribosome binding sites (IRBS) and stop codons. The invention overcomes the principal limitation of known ORF-selector systems, namely the potential for ORF-induced folding interference of the downstream fused reporter, by not fusing the reporter to the ORF, but rather by providing a mechanism for coupled translation of an unfused downstream reporter.

In one aspect, expression vectors capable of eliminating DNA fragments containing an internal ribosome binding site (IRBS) are provided. More particularly, an anti-selection vector that (1) does not contain an operative ribosome binding site upstream of the ORF, and (2) utilizes a negative selection gene in combination with a translational coupling mechanism is provided. The vector is designed to prevent the expression of the ORF unless it contains an IRBS. Thus, the vector enables the expression of the negative selection gene only if the DNA fragment inserted into the vector contains an IRBS. The negative selection gene is not expressed as a fusion with the ORF insert, thereby eliminating any folding interference that may be caused by the ORF. In one embodiment, the negative selection gene is a bacterial gene which is toxic to the cell in which it is expressed, such as SacB or ccdB. Bacterial cells transformed with vectors carrying IRBS-containing fragments will trigger the expression of the toxic gene, which thereby kills the cells, thus eliminating all cells carrying fragments with an IRBS artifact.

In another aspect, the invention provides expression vectors capable of selecting for ORFs without stop codons. These vectors utilize a positive selection gene (selectable marker) in combination with a translational coupling mechanism, which enables the expression of the selection gene only if the DNA fragment inserted into the vector is an ORF that does not contain a stop codon. As with the anti-selection strategy described supra, the selection gene is not expressed as a fusion with the ORF insert. In one embodiment, a bacterial survival gene, such as dihydrofolate rectuctase (DHFR), is used as the selection gene. The expression of DHFR confers resistance to the presence of trimethoprim (TMP). Cells transformed with plasmids carrying fragments containing a stop codon cannot survive, as the stop codon prevents the coupled translation of the downstream DHFR, and no resistance to TMP is conferred, killing these cells.

The invention thus provides methods for efficiently eliminating IRBS and stop codon artifact-containing fragments from a library, using the selection and anti-selection vectors provided herein, without introducing any bias against folding or solubility. The vectors of the invention may be used in a combined approach with folding/solubility assay systems, so that folding and solubility are separately evaluated, after a library has been purged of artifact DNA fragments.

### BRIEF DESCRIPTION OF THE DRAWINGS

FIG. 1 shows a schematic representation of the operative construct of the SacB anti-selection vector described in Example 1, infra. Individual vector elements are further described in Example 1.

FIG. 2 shows a schematic representation of the operative construct of the DHFR selection vector described in Example 3, infra. The individual elements of the vector are described in Example 3.

### DETAILED DESCRIPTION OF THE INVENTION

Unless otherwise defined, all terms of art, notations and other scientific terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. The techniques and procedures described or referenced herein are generally well understood and commonly employed using conventional methodology by those skilled in the art, such as, for example, the widely utilized molecular cloning methodologies described in Sambrook et al., Molecular Cloning: A Laboratory Manual 3rd. edition (2001) Cold Spring Harbor Laboratory Press, Cold Spring Harbor, N.Y. and Current Protocols in Molecular Biology (Ausbel et al., eds., John Wiley & Sons, Inc. 2001. As appropriate, procedures involving the use of commercially available kits and reagents are generally carried out in accordance with manufacturer defined protocols and/or parameters unless otherwise noted.

The invention provides vectors and methods designed for screening large random DNA fragment libraries for the presence of open reading frames that are free of both internal ribosome binding sites (IRBS) and stop codons.

In one aspect of the invention, expression vectors capable of screening out DNA fragments that contain an IRBS are provided. These vectors utilize a negative selection gene in combination with a vector-incorporated translational coupling mechanism, which enables the expression of the negative selection gene only if the DNA fragment inserted into the vector contains an IRBS, as further described below. Importantly, the negative selection gene is not expressed as a fusion with the ORF insert. In one embodiment, the negative selection gene is a bacterial gene which is toxic to the cell in which it is expressed. In this embodiment, bacterial cells transformed with vectors carrying IRBS-containing fragments will trigger the expression of the toxic gene, which thereby kills the cells, thus eliminating all cells carrying fragments with an IRBS artifact. Suitable toxic genes include without limitation those which encode DNA replication inhibitors, cell membrane disrupting proteins, enzymes and the like, such as the levansucrase gene from B. subtillis, SacB, ccdB, Kid, barnase, colicin, granulysin and Hok.

The phenomenon of conjugated translation, or translational coupling, common in bacterial and other microorganism systems, is a translational regulation mechanism in which the translation of an upstream gene regulates the translation of a downstream gene on a polycistronic message (see, for example, Adhin et al., 1990, J. Mol. Biol. 213: 811-818; Andre et al., 2000, FEBS Letters 468: 73-78). In one mechanism, translation of the downstream gene is accomplished by “delivery” of the ribosome from the translated upstream gene to the downstream gene, mediated by the presence of a translational conjugation signal which acts as a weak ribosome binding site. Such translational conjugation signals do not support de novo ribosome binding, but permit a ribosome that has terminated translation of the upstream gene to “scan” the sequence and re-initiate translation of the downstream gene. Thus, translational coupling between two cistrons is mediated by the same ribosome. The ribosome terminates translation at a stop codon in the upstream message, and then scans the downstream sequence, reinitiating translation at a start codon that is close to the upstream message stop. The presence of a translational coupler sequence, a Shine-Dalgarno-like structure, located 5′ of the downstream cistron is believed to promote translational coupling and re-initiation of synthesis (Andre et al., 2000, supra; Sopanjaard and van Duin, 1989, Nucleic Acids Res. 17: 5501-5507; Adhin and van Duin, 1990, J. Mol. Biol. 213: 811-818). The scanning activity of the ribosome is bi-directional, and therefore re-initiated synthesis may occur at an AUG that overlaps the stop codon for the upstream message (e.g., UAAUG, stop in bold, start underlined).

In one embodiment, the anti-IRBS selector of the invention is a plasmid capable of replication in a suitable bacterial host, the operative component of which comprises a suitable promoter, but no SD sequence (or a mutated SD sequence that does not bind the ribosome), an in-frame cloning site for accepting ORF fragment inserts (e.g., a blunt site, such as StuI), and a translational coupler followed by the negative selection gene. An alternative and preferred embodiment adds an in-frame spacer sequence between the ORF insert and the translational coupler (see Examples, infra). The translational coupler comprises a stop codon in the 0-frame of the upstream ORF, and a new start codon, such as ATG or TTG, which need not be in the same frame as the 0-frame of the upstream fusion. The new start codon functions to initiate translation only if the ribosome is delivered from the upstream ORF. In the absence of the translation of the upstream ORF, or if there is a stop codon in the ORF insert, the ribosome fails to reach the coupler, and no translation occurs from the coupler. In addition to the stop and start codons, the translational coupler may contain sequences which act to promote the re-initiation of synthesis by the ribosome. Suitable translational coupler sequences are described in and/or may be identified following the methods used by Andre et al., 2000, supra. In addition to the foregoing elements, the vector may also comprise various restriction sites useful for subcloning, as is well known.

In a particular embodiment, described further in Example 1, infra, a SacB anti-selection vector is provided, and comprises in 5′ to 3′ orientation in a pET28 vector backbone: a T7 promoter, an anti-SD sequence (mutated SD sequence), a blunt cloning site for insertion of DNA fragments, a spacer sequence (third domain of the E. coli periplasmic protein ToIA; Anderluh et al., 2003, Protein Expression & Purification 28: 173-181), a translational coupler with overlapping stop and start codons (TRS No. 23 in Andre et al., supra), and the toxic levansucrase gene from B. subtillis, SacB (Gay et al., 1985, J. Bacteriol. 164: 918-921), all in the 0-frame of the vector. The vector also contains various restriction sites for subcloning and directional cloning. Restriction digested genomic DNA fragments are prepared and blunt-ended, for example, are then cloned into the StuI blunt site.

In the presence of sucrose, expression of SacB is toxic. Thus, if an inserted fragment contains an IRBS, the fragment will be translated from the IRBS, through the translational coupler, resulting in coupled translation of the toxic SacB gene, which will kill the host cells in the presence of sucrose. Fragments without an IRBS will survive, since the vector contains no operative SD sequence, thus preventing translation of the fragment and the coupled translation of the toxic gene. This vector can be used in a method to efficiently delete all clones in a fragment library which contain an IRBS. Surviving clones are those without IRBS.

Expression of the SacB is conditionally toxic, and kills cells only in the presence of sucrose. Accordingly, sucrose levels may be adjusted in order to modulate the stringency of the anti-selection. For example, one may wish to only eliminate those clones bearing fragments with a strong IRBS, while permitting clones bearing fragments with a weak IRBS to survive. This may be enabled by a simple titration of the levels of sucrose required to eliminate clones bearing such fragments.

A related embodiment, described in Example 2, utilizes the ccdB toxin, which interferes with gyrase function, thereby killing cells expressing ccdB. In a particular embodiment, one vector is used to select against clones bearing fragments with an IRBS. The vector is similar to the SacB anti-selection vector described above, except that the ccdB toxin gene is used in place of the SacB gene (IPTG-inducible, T7 promoter-driven pET vector, etc). Only clones bearing fragments without an IRBS will survive, since the vector contains no operative SD sequence, thus preventing the translation of the fragment and the coupled translation of the toxic gene. All clones bearing fragments containing an IRBS are eliminated. A second vector may be used in concert with the ccdB vector in order to modulate the killing effect. The second vector comprises a different backbone (pTET, for example) which drives the expression of the anti-toxin CcdA gene under the control of a different promoter (tet promoter, for example). The use of the anti-toxin vector can be used to increase the stringency of the anti-selection, as increasing the level of expression of the anti-toxin requires a corresponding increase in the expression level of the toxin in order for cells to be killed, the expression of the toxin gene being dependent upon the strength of the IRBS. Thus, this embodiment enables a variably stringent anti-selection scheme.

In another aspect of the invention, expression vectors capable of selecting for ORFs without stop codons are provided. These vectors utilize a positive selection gene (selectable marker) in combination with a vector-incorporated translational coupling mechanism, which enables the expression of the selection gene only if the DNA fragment inserted into the vector is an ORF that does not contain a stop codon. As with the anti-selection strategy described supra, the selection gene is not expressed as a fusion with the ORF insert. Any gene which confers an identifiable change to the cell may be used as the selection gene, including enzymatic markers, non-enzymatic markers, and antibiotic resistance markers, as is very well known. In preferred embodiments, a bacterial survival gene, such as dihydrofolate rectuctase (DHFR), is used as the selection gene. The expression of DHFR confers resistance to the presence of trimethoprim (TMP). E. coli cells expressing DHFR can survive in media containing as much as about 256 μg/ml TMP, whereas E. coli is normally killed by as little as 0.25 μg/ml TMP. An example of a DHFR ORF selection vector is detailed in Example 3, infra.

In this embodiment, the vector is a plasmid capable of replication in a suitable bacterial host, and the operative component of the vector comprises a suitable promoter, including an operational SD sequence, a cloning site for accepting ORF fragment inserts (i.e., a blunt site, such as StuI), a spacer sequence in frame with the 0-frame of the vector and the ORF, and a translational coupler followed by the selection gene. The spacer element is required to place sufficient distance between the ORF fragment and the translational coupler, such that even if a stop codon is present at the 3′ end of the fragment, the ribosome is not delivered to the translational coupler, but can fall off the message. The spacer is important to high fidelity selection. In the absence of the spacer sequence, fragments with stop codons within about 100 base pairs of the end of the fragment will still enable the delivery of the ribosome to the downstream coupler, and will therefore not be distinguished from ORFs completely free of any stop codons. The spacer may be any open reading frame or polypeptide gene. The solubility of such polypeptide spacers cannot interfere with the folding of the downstream selector, since they are not fused together. The translational coupler comprises a stop codon in the 0-frame of the upstream ORF, and a new start codon, such as ATG or TTG, which need not be in the same frame as the 0-frame of the upstream fusion. The new start codon functions to re-initiate translation only if the ribosome is delivered from the upstream ORF. If there is a stop codon in the ORF insert, the ribosome fails to reach the coupler, and no translation occurs from the coupler. In addition to the stop and start codons, the translational coupler may contain sequences which act to promote the re-initiation of synthesis by the ribosome. Suitable translational coupler sequences are described in and/or may be identified following the methods used by Andre et al., 2000, supra. In addition to the foregoing elements, the vector may also comprise various restriction sites useful for subcloning, as is well known.

The no-stop codon ORF selection vectors of the invention function by coupling the translation of a selectable marker gene to the translation of an upstream inserted DNA fragment, without expressing the ORF as a fusion with the selection gene (which can compromise the integrity of the selection, as the folding of the polypeptide encoded by the ORF can interfere with the folding of the downstream fused selection protein). Ribosomes initiate at the functional upstream vector SD. Fragments containing an open reading frame, with no stop codons, will be fully translated through the in-frame spacer and into the translational coupler, which terminates translation and provides a start site for re-initiated translation of the downstream, in-frame, selectable marker.

In yet another aspect of the invention, a method for selecting ORFs which neither contain an internal ribosome binding site (IRBS) nor a stop codon is provided, and utilizes a combination of (1) an anti-selection vector of the invention, which is capable of screening-out ORFs containing an IRBS, and (2) a positive selection vector of the invention, which is capable of screening out fragments containing a stop codon. In one embodiment, the SacB anti-selection and DHFR selection vectors described in Examples 1 and 3 are used, in a stepwise protocol as detailed in Example 4, infra.

Another aspect of the invention provides kits useful in conducting the various assays and methods described, supra. Kits of the invention may contain and facilitate the use of the anti-selection and selection vectors of the invention. Various materials and reagents for practicing the ORF screening assays of the invention may be provided. Kits may contain reagents including, without limitation, the expression vectors of the invention, cell transformation reagents, as well as other solutions or buffers useful in carrying out the assays and other methods of the invention. Kits may also include control samples, materials useful in calibrating the assays of the invention, and containers, tubes, microtiter plates and the like in which assay reactions may be conducted. Kits may be packaged in containers, which may comprise compartments for receiving the contents of the kits, instructions for conducting the assays, etc.

### EXAMPLES

Various aspects of the invention are further described and illustrated by way of the several examples which follow, none of which are intended to limit the scope of the invention.

### Example 1

### SacB Conditional Anti-Selection Vector for Use in Eliminating DNA Fragments with Internal Ribosome Binding Sites

This example describes a conditional anti-selection expression vector construct which is useful in screening-out and eliminating DNA fragments containing an internal ribosome binding site (IRBS) from large random DNA fragment libraries. The vector comprises a cloning site for the DNA fragment, the expression of which is driven by the T7 promoter, with a mutated ribosome binding site that does not permit the translation of the inserted fragment from the 0-frame of the vector. Downstream of the inserted DNA fragment, the vector provides a spacer (in frame with ORF) followed by a translational coupler sequence (in frame with the ORF-spacer fusion), and a toxic gene in-frame with the coupler. In this example, the toxic gene is the levansucrase gene from B. subtillis, SacB (Gay et al., 1985, J. Bacteriol. 164: 918-921). The vector also contains various restriction sites for subcloning and directional cloning.

Briefly, the vector operates as follows. Translation of the upstream inserted DNA fragment ORF cannot occur in the absence of an IRBS in the fragment, as the vector does not contain an operational SD sequence. The objective is to eliminate any clones bearing fragments containing an IRBS. The vector accomplishes this by a negative selection mechanism, whereby clones bearing fragments with an IRBS are translated, leading to the coupled translation of the downstream toxic reporter, SacB. In the presence of sucrose, expression of SacB is toxic to the cells, and the clone does not survive. Only clones carrying ORFs without an IRBS survive the selection, and all clones carrying fragments with an IRBS are eliminated.

### Construct Details:

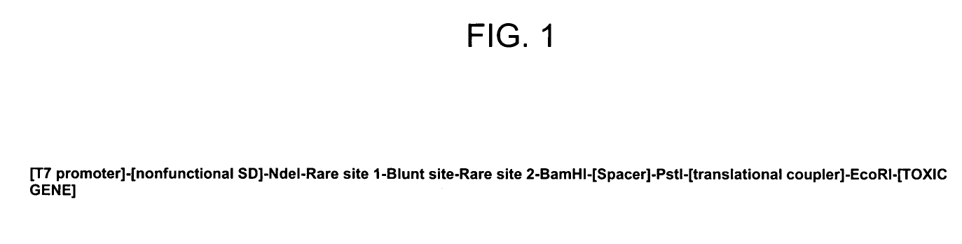

Standard molecular cloning methods are used in the construction of the vector. The vector backbone is pET 28. The organization of the operative cassette is schematically shown in FIG. 1. With reference to FIG. 1, the elements of the cassette are described in 5′ to 3′ orientation, as follows:

BglII T7/Lac Delta SD Ndel>
Mutated/non-operational Shine Dalgarno Sequence
AGATCTCGATCCCGCGAAATTAATACGACTCACTATAGGGGAATTGTG
AGCGGATAACAATTCCCCTCTAGAAATAATTTTGTTTAACTTTATCTT
CCTGATATACATATG

In the above sequence, the BgIII site is used for subcloning into the complete pET28 vector [SEQ ID NO: 18], and contains the T7 RNA polymerase to transcribe mRNA from the construct in strains such as BL21(DE3) which contain T7 RNA polymerase inducible by IPTG. Following the T7 promoter is a mutated/non-functional SD sequence, Delta RBS, which does not bind the 16S rRNA of the ribosome, thus eliminating translation from the 0-frame of the vector RBS. The particular mutation in this pET 28 vector is: AGAAGGAGATATACATATG mutated to TCTTCCTGATATACATATG. The sequence ends with an NdeI restriction site.

Rare site 1: Rare restriction site useful for subsequent directional subcloning of ORFs between vectors. Rare restriction sites suitable for this purpose are well known in the art and include, without limitation, FseI, PacI, PmeI, AvrII.

Blunt site: Blunt cloning site for insertion of DNA fragments to be screened. One suitable site, for example, is StuI (AGG↓CCT), as well as similar restriction sites.

Rare site 2: Rare restriction site useful for subsequent directional subcloning of ORFs between vectors, and which is different from Rare Site 1, above. Rare restriction sites suitable for this purpose are well known in the art and include, without limitation, FseI, PacI, PmeI, AvrII.

BamHI: Restriction site.

Spacer: Polynucleotide spacer of a length sufficient to place adequate distance between the insert ORF fragment and the downstream translational coupler element, such that even if a stop codon is present right at end of ORF insert, the ribosome is not delivered to the coupler, but can fall off the construct mRNA. The spacer is in-frame and fused to the ORF insert and contains no stop codons in the 0-frame of the vector. This spacer element is crucial to high-fidelity selection. In the absence of the spacer, ORFs with stop codons within about 100 bp of the end of the insert will still deliver the ribosome to the downstream coupler, and will not be distinguished from ORFs with no stop codons. Although the solubility of the spacer is irrelevant, in this example, the soluble ToIA domain described in “Expression of proteins using the third domain of the Escherichia coli periplasmic-protein ToIA as a fusion partner” Gregor Anderluh, Is a Gokce and Jeremy H. Lakey, Protein Expression and Purification 28 (2003) 173-181. Thus, the spacer should be greater than about 100 bp. In this example, the ToIA fragment is approximately 300 bp.

PstI: Restriction site.

Translational Coupler: The translational coupler sequence, which comprises a stop codon (TAG, TGA or TAA) in the 0-frame of the upstream ORF-Spacer fusion, and a new start codon, such as ATG or TTG, which need not be in the same frame as the 0-frame of the upstream fusion. The new start codon functions to initiate translation only if the ribosome is delivered from the upstream ORF-spacer fusion, meaning there is no stop codon in the ORF-spacer fusion. In the absence of the translation of the upstream ORF-spacer, or if there is a stop codon in the ORF insert, the ribosome fails to reach the coupler, and no translation occurs from the coupler. The construct described in this example utilizes the synthetic translational coupler described in “Reinitiation of protein synthesis in Escherichia coli can be induced by mRNA cis-elements unrelated to canonical translation initiation signals”, Alessandra Andre, Antimina Puca, Federica Sansone, Anna Brandi, Giovanni Antico, Raffaele A. Calogero, FEBS Letters 468, (2000), 73-78 (TRS sequence no. 23). The coupler sequence is show below, and indicates the initiating codon (underlined):

TATTTATCTTTTTAATGTCT

In this example, the coupler sequence contains overlapping stop and initiation codons. In other words, the upstream spacer (ToIA) and reporter (SacB) are in different frames. The coupler sequence is shown below along with translation in all three reading frames; the bottom translation is in-frame with ToIA, the stop introduced by the coupler indicated with an asterisk. The top translation is the frame of the initiation codon and fused SacB reporter.

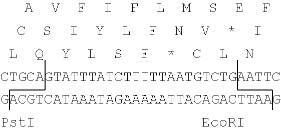

EcoRI: Restriction site.

Toxic Gene: Gene in the frame of the ATG or TTG initiation site of the upstream coupler. Translation is dependent on the ribosome being delivered into the coupler from upstream. Translation cannot occur de novo. In this example, SacB is utilized. Expression in E. coli causes cell death only in the presence of sucrose. In the construct of this example, a modified SacB gene is utilized, the modifications achieving silenced EcoRI, StuI, KpnI, HindIII restriction sites (EcoRI cutting at nucleotide 200, KpnI cutting at nucleotide 1063, StuI cutting at nucleotide 243, and HindIII cutting at nucleotide 1336, with reference to the wild-type SacB sequence as shown in the Table of Sequences, infra. The sequence of the modified SacB gene used in the construct of this example is shown in the Table of Sequences (SEQ ID NO: 2).

As will be appreciated, sucrose levels may be titrated in order to determine the level of sucrose that achieves the killing of cells bearing DNA fragments containing a strong IRBS, while permitting cells bearing a DNA fragment containing a weak IRBS are spared and survive the anti-selection screen.

### Example 2

### ccdB Toxin-Based Conditional Anti-Selection Vector For Use in Eliminating DNA Fragments with Internal Ribosome Binding Sites

This example describes an anti-selection expression vector system which is useful in screening-out and eliminating DNA fragments containing an internal ribosome binding site (IRBS) from large random DNA fragment libraries. The system comprises either one or two vectors.

In one design, one vector is used, this being similar to the SacB anti-selection vector described in Example 1, supra, except that the ccdB gyrase toxin gene is used in place of the SacB gene (IPTG-inducible, T7 promoter-driven pET vector). As in the case of the SacB vector, the ccdB toxin vector comprises a cloning site for the DNA fragment, the expression of which is driven by the T7 promoter, with a mutated ribosome binding site that does not permit the translation of the inserted fragment from the 0-frame of the vector. Downstream of the inserted DNA fragment, the vector provides a spacer (in-frame with ORF) followed by a translational coupler sequence (in-frame with ORF-spacer fusion), and the toxin gene in-frame with the coupler. The vector also contains various restriction sites for subcloning and directional cloning. The elements of the operative cassette of the vector are identical to those present in the SacB anti-selection vector of Example 1, except that the ccdB toxin gene is used instead of SacB.

Translation of the upstream inserted DNA fragment ORF cannot occur in the absence of an IRBS in the fragment, as the vector does not contain an operational SD sequence. The objective is to eliminate any clones bearing fragments containing an IRBS. The vector accomplishes this by a negative selection mechanism, whereby clones bearing fragments with an IRBS are translated, leading to the coupled translation of the downstream toxic reporter, CcdB. Only clones carrying ORFs without an IRBS survive the selection, and all clones carrying fragments with an IRBS are eliminated.

The two-vector system includes a second vector (pTET) which encodes and drives the expression of the anti-toxin CcdA under the control of the tet promoter. The two-vector system permits one to fine-tune the degree of anti-selection, as desired. For example, increasing the expression of the anti-toxin corresponds to a requirement for greater toxin expression to kill susceptible cells, thereby permitting the selection against DNA fragments containing progressively stronger IRBS.

### Example 3

### Generation of DHFR Selection Vector for Use in Eliminating DNA Fragments with Stop Codons

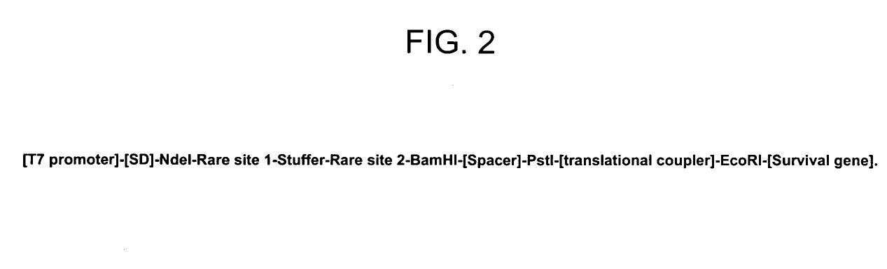

This example describes an expression vector useful in selecting ORFs that do not contain stop codons. The vector is constructed in a pET28 backbone, and comprises a T7 promoter and operational SD sequence driving the in-frame expression of inserted DNA fragments. Downstream of the inserted DNA fragment, the vector provides a spacer in-frame with the 0-frame of the vector and the inserted ORF followed by a translational coupler sequence, and the mouse DHFR gene as a selectable marker. The vector also contains various restriction sites for subcloning and directional cloning. More particularly, the operative cassette of the vector comprises in 5′ to 3′ orientation: the T7 promoter, an SD sequence, a blunt cloning site, a spacer sequence (ToIA) fused in frame with inserted ORFs, a translational coupler sequence (in-frame with the upstream ORF-spacer fusion), and the DHFR gene in frame with the coupler. In a preferred embodiment, a frame-shift stuffer sequence containing stop codons is inserted between two blunt restriction sites (e.g., StuI) in order to provide a means for reducing background expression of DHFR in clones that did not incorporate an insert. Digestion with the blunt cutter releases the frame-shift stuffer, and the blunt-ended fragment is inserted therein. In vectors without inserts, the stuffer functions to terminate translation. A schematic diagram of the foregoing elements of the construct, including the various restriction sites incorporated therein, is shown in FIG. 2. Details of the construct are provided below.

### Construct Details:

Standard molecular cloning methods are used in the construction of the vector. The vector backbone is a pET 28. The organization of the operative cassette is schematically shown in FIG. 2. With reference to FIG. 2, the elements of the cassette are described in 5′ to 3′ orientation, as follows:

BglII T7/Lac Delta SD Ndel>
Wild Type Shine Dalgarno Sequence
AGATCTCGATCCCGCGAAATTAATACGACTCACTATAGGGGAATTGTG
AGCGGATAACAATTCCCCTCTAGAAATAATTTTGTTTAACTTTAAGAA
GGAGATATACATATG

In the above sequence, the BgIII site is used for subcloning into the complete pET28 vector [SEQ ID NO: 18], and contains the T7 RNA polymerase to transcribe mRNA from the construct in strains such as BL21(DE3) which contain T7 RNA polymerase inducible by IPTG. Following the T7 promoter is a functional SD sequence. The sequence ends with an NdeI restriction site.

Rare site 1: Rare restriction site useful for subsequent directional subcloning of ORFs between vectors. Rare restriction sites suitable for this purpose are well known in the art and include, without limitation, FseI, PacI, PmeI, AvrII.

Stuffer: Frame-shift element with stops, containing a blunt restriction site e.g., StuI or similar, including for example SEQ ID NO: 16 and SEQ ID NO: 17.

Rare site 2: Rare restriction site useful for subsequent directional subcloning of ORFs between vectors, and which is different from Rare Site 1, above. Rare restriction sites suitable for this purpose are well known in the art and include, without limitation, FseI, PacI, PmeI, AvrII.

BamHI: Restriction site.

Spacer: Polynucleotide spacer of a length sufficient to place adequate distance between the insert ORF fragment and the downstream translational coupler element, such that even if a stop codon is present right at end of ORF insert, the ribosome is not delivered to the coupler, but can fall off the construct mRNA. The spacer is in-frame and fused to the ORF insert and contains no stop codons in the 0-frame of the vector. This spacer element is crucial to high-fidelity selection. In the absence of the spacer, ORFs with stop codons within about 100 bp of the end of the insert will still deliver the ribosome to the downstream coupler, and will not be distinguished from ORFs with no stop codons. Although the solubility of the spacer is irrelevant, in this example, the soluble ToIA domain described in “Expression of proteins using the third domain of the Escherichia coli periplasmic-protein ToIA as a fusion partner” Gregor Anderluh, Is a Gokce and Jeremy H. Lakey, Protein Expression and Purification 28 (2003) 173-181. Thus, the spacer should be greater than about 100 bp. In this example, the ToIA fragment is approximately 300 bp.

PstI: Restriction site.

Translational Coupler: The translational coupler sequence, which comprises a stop codon (TAG, TGA or TAA) in the 0-frame of the upstream ORF-Spacer fusion, and a new start codon, such as ATG or TTG, which need not be in the same frame as the 0-frame of the upstream fusion. The new start codon functions to initiate translation only if the ribosome is delivered from the upstream ORF-spacer fusion, meaning there is no stop codon in the ORF-spacer fusion. In the absence of the translation of the upstream ORF-spacer, or if there is a stop codon in the ORF insert, the ribosome fails to reach the coupler, and no translation occurs from the coupler. The construct described in this example utilizes the synthetic translational coupler described in “Reinitiation of protein synthesis in Escherichia coli can be induced by mRNA cis-elements unrelated to canonical translation initiation signals”, Alessandra Andre, Antimina Puca, Federica Sansone, Anna Brandi, Giovanni Antico, Raffaele A. Calogero, FEBS Letters 468, (2000), 73-78 (TRS sequence no. 23). The coupler sequence is show below, and indicates the initiating codon (underlined):

TATTTATCTTTTTAATGTCT

In this example, the coupler sequence contains overlapping stop and initiation codons. In other words, the upstream spacer (ToIA) and reporter (DHFR) are in different frames. The coupler sequence is shown below along with translation in all three reading frames; the bottom translation is in-frame with ToIA, the stop introduced by the coupler indicated with an asterisk. The top translation is the frame of the initiation codon and fused SacB reporter.

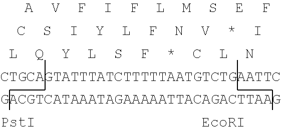

EcoRI: Restriction site.

Survival Gene: Gene in the frame of the ATG or TTG initiation site of the upstream coupler. Translation is dependent on the ribosome being delivered into the coupler from upstream. Translation cannot occur de novo. In this example, the marine DHFR gene is utilized (mouse dihydrofolate reductase). Expression of the DHFR gene confers resistance to the antibiotic trimethoprim. Cells expressing mDHFR can survive even in the presence of 256 ug/ml trimethoprim. In the absence of the mDHFR protein, E. coli is normally killed at >0.25 ug/ml trimethoprim (TMP). The mDHFR gene sequence is shown in the Table of Sequences (SEQ ID NO: 3).

### Example 4

### Method for Selecting ORFs with No Ribosome Binding Sites and No Stop Codons

In this Example, a method for selecting ORFs which neither contain an internal ribosome binding site (IRBS) nor a stop codon is described, the method utilizing the vectors of Examples 1 and 3.

The SacB anti-selection and DHFR selection vectors described in Examples 1 and 3 are used, in the stepwise protocol described below.

STEP 1: Random fragment ORFs are cloned into the blunt site of the SacB anti-selection vector (StuI). BL21 (DE3) cells are transformed with ORF insert-containing plasmid, and cells are plated on 10% w/v LB agar plates containing 20 μM IPTG and 2-5% sucrose. Transformed cells containing ORFs with an IRBS will generate the coupled translation of the SacB gene and will be killed in the presence of sucrose.

STEP 2: Plasmids are prepared from the surviving cells, and are digested with restriction enzymes cutting at the rare sites 1 and 2 of the construct, releasing the ORF fragment inserts, which are then size-fractionated by agarose gel electrophoresis and purified.

STEP 3: Purified ORF inserts are directionally cloned into the DHFR selection vector of Example 3. In this example, the rare sites 1 and 2 of the SacB anti-selection and DHFR selection vectors are the same in order to permit the directional sub-cloning step. BL21 (DE3) cells are transformed with ORF insert-containing plasmid, and cells are plated on 10% w/v LB agar plates containing 20 μM IPTG and 50 μg/ml trimethoprim. Only transformed cells containing ORFs with no stop codons will result in the coupled translation of the DHFR gene, and thus survive.

STEP 4: Surviving cells may be pooled and plasmids prepared. The inserts are now available for subcloning into other vectors, such as the pTET split-GFP solubility tag vectors described in United States Patent Application No. US20050221343-A1, equipped with a cloning site adaptor containing the in-frame rare cutters Rare Site 1 and Rare Site 2.

All publications, patents, and patent applications cited in this specification are herein incorporated by reference as if each individual publication or patent application were specifically and individually indicated to be incorporated by reference.

The present invention is not to be limited in scope by the embodiments disclosed herein, which are intended as single illustrations of individual aspects of the invention, and any which are functionally equivalent are within the scope of the invention. Various modifications to the models and methods of the invention, in addition to those described herein, will become apparent to those skilled in the art from the foregoing description and teachings, and are similarly intended to fall within the scope of the invention. Such modifications or other embodiments can be practiced without departing from the true scope and spirit of the invention.

TABLE OF SEQUENCES

SEQ ID NO: 1
Wild-type SacB gene [levansucrase gene from
Bacillus subtillis]:
GCGTTTGCGAAAGAAACGAACCAAAAGCCATATAAGGAAACATACGGCA
TTTCCCATATTACACGCCATGATATGCTGCAAATCCCTGAACAGCAAAA
AAATGAAAAATATCAAGTTCCTGAATTCGATTCGTCCACAATTAAAAAT
ATCTCTTCTGCAAAAGGCCTGGACGTTTGGGACAGCTGGCCATTACAAA
ACGCTGACGGCACTGTCGCAAACTATCACGGCTACCACATCGTCTTTGC
ATTAGCCGGAGATCCTAAAAATGCGGATGACACATCGATTTACATGTTC
TATCAAAAAGTCGGCGAAACTTCTATTGACAGCTGGAAAAACGCTGGCC
GCGTCTTTAAAGACAGCGACAAATTCGATGCAAATGATTCTATCCTAAA
AGACCAAACACAAGAATGGTCAGGTTCAGCCACATTTACATCTGACGGA
AAAATCCGTTTATTCTACACTGATTTCTCCGGTAAACATTACGGCAAAC
AAACACTGACAACTGCACAAGTTAACGTATCAGCATCAGACAGCTCTTT
GAACATCAACGGTGTAGAGGATTATAAATCAATCTTTGACGGTGACGGA
AAAACGTATCAAAATGTACAGCAGTTCATCGATGAAGGCAACTACAGCT
CAGGCGACAACCATACGCTGAGAGATCCTCACTACGTAGAAGATAAAGG
CCACAAATACTTAGTATTTGAAGCAAACACTGGAACTGAAGATGGCTAC
CAAGGCGAAGAATCTTTATTTAACAAAGCATACTATGGCAAAAGCACAT
CATTCTTCCGTCAAGAAAGTCAAAAACTTCTGCAAAGCGATAAAAAACG
CACGGCTGAGTTAGCAAACGGCGCTCTCGGTATGATTGAGCTAAACGAT
GATTACACACTGAAAAAAGTGATGAAACCGCTGATTGCATCTAACACAG
TAACAGATGAAATTGAACGCGCGAACGTCTTTAAAATGAACGGCAAATG
GTACCTGTTCACTGACTCCCGCGGATCAAAAATGACGATTGACGGCATT
ACGTCTAACGATATTTACATGCTTGGTTATGTTTCTAATTCTTTAACTG
GCCCATACAAGCCGCTGAACAAAACTGGCCTTGTGTTAAAAATGGATCT
TGATCCTAACGATGTAACCTTTACTTACTCACACTTCGCTGTACCTCAA
GCGAAAGGAAACAATGTCGTGATTACAAGCTATATGACAAACAGAGGAT
TCTACGCAGACAAACAATCAACGTTTGCGCCAAGCTTCCTGCTGAACAT
CAAAGGCAAGAAAACATCTGTTGTCAAAGACAGCATCCTTGAACAAGGA
CAATTAACAGTTAACAAA
SEQ ID NO: 2
Modified SacB gene sequence (silenced restriction
sites for EcoRI, StuI, KpnI, HindIII)
GCGTTTGCGAAAGAAACGAACCAAAAGCCATATAAGGAAACATACGGCA
TTTCCCATATTACACGCCATGATATGCTGCAAATCCCTGAACAGCAAAA
AAATGAAAAATATCAAGTTCCTGAGTTCGATTCGTCCACAATTAAAAAT
ATCTCTTCTGCAAAGGGCCTGGACGTTTGGGACAGCTGGCCATTACAAA
ACGCTGACGGCACTGTCGCAAACTATCACGGCTACCACATCGTCTTTGC
ATTAGCCGGAGATCCTAAAAATGCGGATGACACATCGATTTACATGTTC
TATCAAAAAGTCGGCGAAACTTCTATTGACAGCTGGAAAAACGCTGGCC
GCGTCTTTAAAGACAGCGACAAATTCGATGCAAATGATTCTATCCTAAA
AGACCAAACACAAGAATGGTCAGGTTCAGCCACATTTACATCTGACGGA
AAAATCCGTTTATTCTACACTGATTTCTCCGGTAAACATTACGGCAAAC
AAACACTGACAACTGCACAAGTTAACGTATCAGCATCAGACAGCTCTTT
GAACATCAACGGTGTAGAGGATTATAAATCAATCTTTGACGGTGACGGA
AAAACGTATCAAAATGTACAGCAGTTCATCGATGAAGGCAACTACAGCT
CAGGCGACAACCATACGCTGAGAGATCCTCACTACGTAGAAGATAAAGG
CCACAAATACTTAGTATTTGAAGCAAACACTGGAACTGAAGATGGCTAC
CAAGGCGAAGAATCTTTATTTAACAAAGCATACTATGGCAAAAGCACAT
CATTCTTCCGTCAAGAAAGTCAAAAACTTCTGCAAAGCGATAAAAAACG
CACGGCTGAGTTAGCAAACGGCGCTCTCGGTATGATTGAGCTAAACGAT
GATTACACACTGAAAAAAGTGATGAAACCGCTGATTGCATCTAACACAG
TAACAGATGAAATTGAACGCGCGAACGTCTTTAAAATGAACGGCAAATG
GTATCTGTTCACTGACTCCCGCGGATCAAAAATGACGATTGACGGCATT
ACGTCTAACGATATTTACATGCTTGGTTATGTTTCTAATTCTTTAACTG
GCCCATACAAGCCGCTGAACAAAACTGGCCTTGTGTTAAAAATGGATCT
TGATCCTAACGATGTAACCTTTACTTACTCACACTTCGCTGTACCTCAA
GCGAAAGGAAACAATGTCGTGATTACAAGCTATATGACAAACAGAGGAT
TCTACGCAGACAAACAATCAACGTTTGCGCCATCTTTCCTGCTGAACAT
CAAAGGCAAGAAAACATCTGTTGTCAAAGACAGCATCCTTGAACAAGGA
CAATTAACAGTTAACAAA
SEQ ID NO: 3
Mouse DHFR gene sequence:
GTTCGACCATTGAACTGCATCGTCGCCGTGTCCCAAAATATGGGGATTG
GCAAGAACGGAGACCTACCCTGGCCTCCGCTCAGGAACGAGTTCAAGTA
CTTCCAAAGAATGACCACAACCTCTTCAGTGGAAGGTAAACAGAATCTG
GTGATTATGGGTAGGAAAACCTGGTTCTCCATTCCTGAGAAGAATCGAC
CTTTAAAGGACAGAATTAATATAGTTCTCAGTAGAGAACTCAAAGAACC
ACCACGAGGAGCTCATTTTCTTGCCAAAAGTTTGGATGATGCCTTAAGA
CTTATTGAACAACCGGAATTGGCAAGTAAAGTAGACATGGTTTGGATAG
TCGGAGGCAGTTCTGTTTACCAGGAAGCCATGAATCAACCAGGCCACCT
TAGACTCTTTGTGACAAGGATCATGCAGGAATTTGAAAGTGACACGTTT
TTCCCAGAAATTGATTTGGGGAAATATAAACTTCTCCCAGAATACCCAG
GCGTCCTCTCTGAGGTCCAGGAGGAAAAAGGCATCAAGTATAAGTTTGA
AGTCTACGAGAAGAAAGAC
SEQ ID NO: 4 BglII T7/Lac SD Ndel>
Wild Type Shine Dalgarno Sequence
AGATCTCGATCCCGCGAAATTAATACGACTCACTATAGGGGAATTGTGA
GCGGATAACAATTCCCCTCTAGAAATAATTTTGTTTAACTTTAAGAAGG
AGATATACATATG
SEQ ID NO: 5 BglII T7/Lac Delta SD Ndel>
Mutated/non-operational Shine Dalgarno Sequence
AGATCTCGATCCCGCGAAATTAATACGACTCACTATAGGGGAATTGTGA
GCGGATAACAATTCCCCTCTAGAAATAATTTTGTTTAACTTTATCTTCC
TGATATACATATG
SEQ ID NO: 6 Ndel FS1 BamHI> Frame Shift Stuffer
(Examples 1-3)
CATATGTGTTAACTGAGTAGGATCC
SEQ ID NO: 7 TolA Spacer; TolA gene encoding amino
acid residues 329 to 421 of the native TolA protein
AACAATGGCGCATCAGGGGCCGATATCAATAACTATGCCGGGCAGATTA
AATCTGCTATCGAAAGTAAGTTCTATGACGCATCGTCCTATGCAGGCAA
AACCTGTACGCTGCGCATAAAACTGGCACCCGATGGTATGTTACTGGAT
ATCAAACCTGAAGGTGGCGATCCCGCACTTTGTCAGGCTGCGTTGGCAG
CAGCTAAACTTGCGAAGATCCCGAAACCACCAAGCCAGGCAGTATATGA
AGTGTTCAAAAACGCGCCATTGGACTTCAAACCG
SEQ ID NO: 8 Andre et al., 2000, supra.
Translational Coupler sequence no. 23
TATTTATCTTTTTAATGTCT
SEQ ID NO: 9 EcoRI Modified SacB STOP Xhol
GAATTCGCGTTTGCGAAAGAAACGAACCAAAAGCCATATAAGGAAACAT
ACGGCATTTCCCATATTACACGCCATGATATGCTGCAAATCCCTGAACA
GCAAAAAAATGAAAAATATCAAGTTCCTGAGTTCGATTCGTCCACAATT
AAAAATATCTCTTCTGCAAAGGGCCTGGACGTTTGGGACAGCTGGCCAT
TACAAAACGCTGACGGCACTGTCGCAAACTATCACGGCTACCACATCGT
CTTTGCATTAGCCGGAGATCCTAAAAATGCGGATGACACATCGATTTAC
ATGTTCTATCAAAAAGTCGGCGAAACTTCTATTGACAGCTGGAAAAACG
CTGGCCGCGTCTTTAAAGACAGCGACAAATTCGATGCAAATGATTCTAT
CCTAAAAGACCAAACACAAGAATGGTCAGGTTCAGCCACATTTACATCT
GACGGAAAAATCCGTTTATTCTACACTGATTTCTCCGGTAAACATTACG
GCAAACAAACACTGACAACTGCACAAGTTAACGTATCAGCATCAGACAG
CTCTTTGAACATCAACGGTGTAGAGGATTATAAATCAATCTTTGACGGT
GACGGAAAAACGTATCAAAATGTACAGCAGTTCATCGATGAAGGCAACT
ACAGCTCAGGCGACAACCATACGCTGAGAGATCCTCACTACGTAGAAGA
TAAAGGCCACAAATACTTAGTATTTGAAGCAAACACTGGAACTGAAGAT
GGCTACCAAGGCGAAGAATCTTTATTTAACAAAGCATACTATGGCAAAA
GCACATCATTCTTCCGTCAAGAAAGTCAAAAACTTCTGCAAAGCGATAA
AAAACGCACGGCTGAGTTAGCAAACGGCGCTCTCGGTATGATTGAGCTA
AACGATGATTACACACTGAAAAAAGTGATGAAACCGCTGATTGCATCTA
ACACAGTAACAGATGAAATTGAACGCGCGAACGTCTTTAAAATGAACGG
CAAATGGTATCTGTTCACTGACTCCCGCGGATCAAAAATGACGATTGAC
GGCATTACGTCTAACGATATTTACATGCTTGGTTATGTTTCTAATTCTT
TAACTGGCCCATACAAGCCGCTGAACAAAACTGGCCTTGTGTTAAAAAT
GGATCTTGATCCTAACGATGTAACCTTTACTTACTCACACTTCGCTGTA
CCTCAAGCGAAAGGAAACAATGTCGTGATTACAAGCTATATGACAAACA
GAGGATTCTACGCAGACAAACAATCAACGTTTGCGCCATCTTTCCTGCT
GAACATCAAAGGCAAGAAAACATCTGTTGTCAAAGACAGCATCCTTGAA
CAAGGACAATTAACAGTTAACAAATAACTCGAG
SEQ ID NO: 10 EcoRI mouse DHFR STOP Xhol>
GAATTCGTTCGACCATTGAACTGCATCGTCGCCGTGTCCCAAAATATGG
GGATTGGCAAGAACGGAGACCTACCCTGGCCTCCGCTCAGGAACGAGTT
CAAGTACTTCCAAAGAATGACCACAACCTCTTCAGTGGAAGGTAAACAG
AATCTGGTGATTATGGGTAGGAAAACCTGGTTCTCCATTCCTGAGAAGA
ATCGACCTTTAAAGGACAGAATTAATATAGTTCTCAGTAGAGAACTCAA
AGAACCACCACGAGGAGCTCATTTTCTTGCCAAAAGTTTGGATGATGCC
TTAAGACTTATTGAACAACCGGAATTGGCAAGTAAAGTAGACATGGTTT
GGATAGTCGGAGGCAGTTCTGTTTACCAGGAAGCCATGAATCAACCAGG
CCACCTTAGACTCTTTGTGACAAGGATCATGCAGGAATTTGAAAGTGAC
ACGTTTTTCCCAGAAATTGATTTGGGGAAATATAAACTTCTCCCAGAAT
ACCCAGGCGTCCTCTCTGAGGTCCAGGAGGAAAAAGGCATCAAGTATAA
GTTTGAAGTCTACGAGAAGAAAGACTAACTCGAG
SEQ ID NO: 11 ccdB
TCTGCCCGGCAGTTTAAGGTTTACACCTATAAAAGAGAGAGCCGTTATC
GTCTGTTTGTGGATGTACAGAGTGATATTATTGACACGCCGGGGCGACG
GATGGTGATCCCCCTGGCCAGTGCACGTCTGCTGTCAGATAAAGTCTCC
CGTGAACTTTACCCGGTGGTGCATATCGGGGATGAAAGCTGGCGCATGA
TGACCACCGATATGGCCAGTGTGCCGGTCTCCGTTATCGGGGAAGAAGT
GGCTGATCTCAGCCACCGCGAAAATGACATCAAAAACGCCATTAACCTG
ATGTTCTGGGGAATA
SEQ ID NO: 12 EcoRI ccdB STOP Xhol
GAATTCTCTGCCCGGCAGTTTAAGGTTTACACCTATAAAAGAGAGAGCC
GTTATCGTCTGTTTGTGGATGTACAGAGTGATATTATTGACACGCCGGG
GCGACGGATGGTGATCCCCCTGGCCAGTGCACGTCTGCTGTCAGATAAA
GTCTCCCGTGAACTTTACCCGGTGGTGCATATCGGGGATGAAAGCTGGC
GCATGATGACCACCGATATGGCCAGTGTGCCGGTCTCCGTTATCGGGGA
AGAAGTGGCTGATCTCAGCCACCGCGAAAATGACATCAAAAACGCCATT
AACCTGATGTTCTGGGGAATATAACTCGAG
SEQ ID NO: 13 BglII T7/Lac Delta SD Ndel FS1 BamHI
TolA PstI Calogero TC EcoRI Modified SacB STOP
Xhol> Eaxample 1
AGATCTCGATCCCGCGAAATTAATACGACTCACTATAGGGGAATTGTGA
GCGGATAACAATTCCCCTCTAGAAATAATTTTGTTTAACTTTATCTTCC
TGATATACATATGTGTTAACTGAGTAGGATCCAACAATGGCGCATCAGG
GGCCGATATCAATAACTATGCCGGGCAGATTAAATCTGCTATCGAAAGT
AAGTTCTATGACGCATCGTCCTATGCAGGCAAAACCTGTACGCTGCGCA
TAAAACTGGCACCCGATGGTATGTTACTGGATATCAAACCTGAAGGTGG
CGATCCCGCACTTTGTCAGGCTGCGTTGGCAGCAGCTAAACTTGCGAAG
ATCCCGAAACCACCAAGCCAGGCAGTATATGAAGTGTTCAAAAACGCGC
CATTGGACTTCAAACCGCTGCAGTATTTATCTTTTTAATGTCTGAATTC
GCGTTTGCGAAAGAAACGAACCAAAAGCCATATAAGGAAACATACGGCA
TTTCCCATATTACACGCCATGATATGCTGCAAATCCCTGAACAGCAAAA
AAATGAAAAATATCAAGTTCCTGAGTTCGATTCGTCCACAATTAAAAAT
ATCTCTTCTGCAAAGGGCCTGGACGTTTGGGACAGCTGGCCATTACAAA
ACGCTGACGGCACTGTCGCAAACTATCACGGCTACCACATCGTCTTTGC
ATTAGCCGGAGATCCTAAAAATGCGGATGACACATCGATTTACATGTTC
TATCAAAAAGTCGGCGAAACTTCTATTGACAGCTGGAAAAACGCTGGCC
GCGTCTTTAAAGACAGCGACAAATTCGATGCAAATGATTCTATCCTAAA
AGACCAAACACAAGAATGGTCAGGTTCAGCCACATTTACATCTGACGGA
AAAATCCGTTTATTCTACACTGATTTCTCCGGTAAACATTACGGCAAAC
AAACACTGACAACTGCACAAGTTAACGTATCAGCATCAGACAGCTCTTT
GAACATCAACGGTGTAGAGGATTATAAATCAATCTTTGACGGTGACGGA
AAAACGTATCAAAATGTACAGCAGTTCATCGATGAAGGCAACTACAGCT
CAGGCGACAACCATACGCTGAGAGATCCTCACTACGTAGAAGATAAAGG
CCACAAATACTTAGTATTTGAAGCAAACACTGGAACTGAAGATGGCTAC
CAAGGCGAAGAATCTTTATTTAACAAAGCATACTATGGCAAAAGCACAT
CATTCTTCCGTCAAGAAAGTCAAAAACTTCTGCAAAGCGATAAAAAACG
CACGGCTGAGTTAGCAAACGGCGCTCTCGGTATGATTGAGCTAAACGAT
GATTACACACTGAAAAAAGTGATGAAACCGCTGATTGCATCTAACACAG
TAACAGATGAAATTGAACGCGCGAACGTCTTTAAAATGAACGGCAAATG
GTATCTGTTCACTGACTCCCGCGGATCAAAAATGACGATTGACGGCATT
ACGTCTAACGATATTTACATGCTTGGTTATGTTTCTAATTCTTTAACTG
GCCCATACAAGCCGCTGAACAAAACTGGCCTTGTGTTAAAAATGGATCT
TGATCCTAACGATGTAACCTTTACTTACTCACACTTCGCTGTACCTCAA
GCGAAAGGAAACAATGTCGTGATTACAAGCTATATGACAAACAGAGGAT
TCTACGCAGACAAACAATCAACGTTTGCGCCATCTTTCCTGCTGAACAT
CAAAGGCAAGAAAACATCTGTTGTCAAAGACAGCATCCTTGAACAAGGA
CAATTAACAGTTAACAAATAACTCGAG
SEQ 14 BglII T7/Lac Delta SD Ndel FS1 BamHI TolA
Pstl Calogero TC EcoRI ccDB STOP Xhol>
AGATCTCGATCCCGCGAAATTAATACGACTCACTATAGGGGAATTGTGA
GCGGATAACAATTCCCCTCTAGAAATAATTTTGTTTAACTTTATCTTCC
TGATATACATATGTGTTAACTGAGTAGGATCCAACAATGGCGCATCAGG
GGCCGATATCAATAACTATGCCGGGCAGATTAAATCTGCTATCGAAAGT
AAGTTCTATGACGCATCGTCCTATGCAGGCAAAACCTGTACGCTGCGCA
TAAAACTGGCACCCGATGGTATGTTACTGGATATCAAACCTGAAGGTGG
CGATCCCGCACTTTGTCAGGCTGCGTTGGCAGCAGCTAAACTTGCGAAG
ATCCCGAAACCACCAAGCCAGGCAGTATATGAAGTGTTCAAAAACGCGC
CATTGGACTTCAAACCGCTGCAGTATTTATCTTTTTAATGTCTGAATTC
TCTGCCCGGCAGTTTAAGGTTTACACCTATAAAAGAGAGAGCCGTTATC
GTCTGTTTGTGGATGTACAGAGTGATATTATTGACACGCCGGGGCGACG
GATGGTGATCCCCCTGGCCAGTGCACGTCTGCTGTCAGATAAAGTCTCC
CGTGAACTTTACCCGGTGGTGCATATCGGGGATGAAAGCTGGCGCATGA
TGACCACCGATATGGCCAGTGTGCCGGTCTCCGTTATCGGGGAAGAAGT
GGCTGATCTCAGCCACCGCGAAAATGACATCAAAAACGCCATTAACCTG
ATGTTCTGGGGAATATAACTCGAG
SEQ 15 BglII T7/Lac SD Ndel FS1 BamHI TolA Pstl
Calogero TC EcoRI mDHFR STOP Xhol>
AGATCTCGATCCCGCGAAATTAATACGACTCACTATAGGGGAATTGTGA
GCGGATAACAATTCCCCTCTAGAAATAATTTTGTTTAACTTTAAGAAGG
AGATATACATATGTGTTAACTGAGTAGGATCCAACAATGGCGCATCAGG
GGCCGATATCAATAACTATGCCGGGCAGATTAAATCTGCTATCGAAAGT
AAGTTCTATGACGCATCGTCCTATGCAGGCAAAACCTGTACGCTGCGCA
TAAAACTGGCACCCGATGGTATGTTACTGGATATCAAACCTGAAGGTGG
CGATCCCGCACTTTGTCAGGCTGCGTTGGCAGCAGCTAAACTTGCGAAG
ATCCCGAAACCACCAAGCCAGGCAGTATATGAAGTGTTCAAAAACGCGC
CATTGGACTTCAAACCGCTGCAGTATTTATCTTTTTAATGTCTGAATTC
GTTCGACCATTGAACTGCATCGTCGCCGTGTCCCAAAATATGGGGATTG
GCAAGAACGGAGACCTACCCTGGCCTCCGCTCAGGAACGAGTTCAAGTA
CTTCCAAAGAATGACCACAACCTCTTCAGTGGAAGGTAAACAGAATCTG
GTGATTATGGGTAGGAAAACCTGGTTCTCCATTCCTGAGAAGAATCGAC
CTTTAAAGGACAGAATTAATATAGTTCTCAGTAGAGAACTCAAAGAACC
ACCACGAGGAGCTCATTTTCTTGCCAAAAGTTTGGATGATGCCTTAAGA
CTTATTGAACAACCGGAATTGGCAAGTAAAGTAGACATGGTTTGGATAG
TCGGAGGCAGTTCTGTTTACCAGGAAGCCATGAATCAACCAGGCCACCT
TAGACTCTTTGTGACAAGGATCATGCAGGAATTTGAAAGTGACACGTTT
TTCCCAGAAATTGATTTGGGGAAATATAAACTTCTCCCAGAATACCCAG
GCGTCCTCTCTGAGGTCCAGGAGGAAAAAGGCATCAAGTATAAGTTTGA
AGTCTACGAGAAGAAAGACTAACTCGAG
SEQ 16 Ndel Pacl StuI Pmel Frame Shift stuffer
BamHI>
CATATGTTAATTAAATCAGGCCTCTGGTTTAAACGGATCC
SEQ 17 Ndel AvrIl StuI Fsel Frame Shift stuffer
BamHI>
CATATGTCCCTAGGTGGAGGCCTCTGGGCCGGCCGGATCC
SEQ 18 pET28 vector sequence, including frame
shift stuffer of SEQ ID NO: 6, encoding a 6-HIS
C-terminal tag (BglII site is underlined; Xhol
site is double-underlined)
TGGCGAATGGGACGCGCCCTGTAGCGGCGCATTAAGCGCGGCGGGTGTG
GTGGTTACGCGCAGCGTGACCGCTACACTTGCCAGCGCCCTAGCGCCCG
CTCCTTTCGCTTTCTTCCCTTCCTTTCTCGCCACGTTCGCCGGCTTTCC
CCGTCAAGCTCTAAATCGGGGGCTCCCTTTAGGGTTCCGATTTAGTGCT
TTACGGCACCTCGACCCCAAAAAACTTGATTAGGGTGATGGTTCACGTA
GTGGGCCATCGCCCTGATAGACGGTTTTTCGCCCTTTGACGTTGGAGTC
CACGTTCTTTAATAGTGGACTCTTGTTCCAAACTGGAACAACACTCAAC
CCTATCTCGGTCTATTCTTTTGATTTATAAGGGATTTTGCCGATTTCGG
CCTATTGGTTAAAAAATGAGCTGATTTAACAAAAATTTAACGCGAATTT
TAACAAAATATTAACGTTTACAATTTCAGGTGGCACTTTTCGGGGAAAT
GTGCGCGGAACCCCTATTTGTTTATTTTTCTAAATACATTCAAATATGT
ATCCGCTCATGAATTAATTCTTAGAAAAACTCATCGAGCATCAAATGAA
ACTGCAATTTATTCATATCAGGATTATCAATACCATATTTTTGAAAAAG
CCGTTTCTGTAATGAAGGAGAAAACTCACCGAGGCAGTTCCATAGGATG
GCAAGATCCTGGTATCGGTCTGCGATTCCGACTCGTCCAACATCAATAC
AACCTATTAATTTCCCCTCGTCAAAAATAAGGTTATCAAGTGAGAAATC
ACCATGAGTGACGACTGAATCCGGTGAGAATGGCAAAAGTTTATGCATT
TCTTTCCAGACTTGTTCAACAGGCCAGCCATTACGCTCGTCATCAAAAT
CACTCGCATCAACCAAACCGTTATTCATTCGTGATTGCGCCTGAGCGAG
ACGAAATACGCGATCGCTGTTAAAAGGACAATTACAAACAGGAATCGAA
TGCAACCGGCGCAGGAACACTGCCAGCGCATCAACAATATTTTCACCTG
AATCAGGATATTCTTCTAATACCTGGAATGCTGTTTTCCCGGGGATCGC
AGTGGTGAGTAACCATGCATCATCAGGAGTACGGATAAAATGCTTGATG
GTCGGAAGAGGCATAAATTCCGTCAGCCAGTTTAGTCTGACCATCTCAT
CTGTAACATCATTGGCAACGCTACCTTTGCCATGTTTCAGAAACAACTC
TGGCGCATCGGGCTTCCCATACAATCGATAGATTGTCGCACCTGATTGC
CCGACATTATCGCGAGCCCATTTATACCCATATAAATCAGCATCCATGT
TGGAATTTAATCGCGGCCTAGAGCAAGACGTTTCCCGTTGAATATGGCT
CATAACACCCCTTGTATTACTGTTTATGTAAGCAGACAGTTTTATTGTT
CATGACCAAAATCCCTTAACGTGAGTTTTCGTTCCACTGAGCGTCAGAC
CCCGTAGAAAAGATCAAAGGATCTTCTTGAGATCCTTTTTTTCTGCGCG
TAATCTGCTGCTTGCAAACAAAAAAACCACCGCTACCAGCGGTGGTTTG
TTTGCCGGATCAAGAGCTACCAACTCTTTTTCCGAAGGTAACTGGCTTC
AGCAGAGCGCAGATACCAAATACTGTCCTTCTAGTGTAGCCGTAGTTAG
GCCACCACTTCAAGAACTCTGTAGCACCGCCTACATACCTCGCTCTGCT
AATCCTGTTACCAGTGGCTGCTGCCAGTGGCGATAAGTCGTGTCTTACC
GGGTTGGACTCAAGACGATAGTTACCGGATAAGGCGCAGCGGTCGGGCT
GAACGGGGGGTTCGTGCACACAGCCCAGCTTGGAGCGAACGACCTACAC
CGAACTGAGATACCTACAGCGTGAGCTATGAGAAAGCGCCACGCTTCCC
GAAGGGAGAAAGGCGGACAGGTATCCGGTAAGCGGCAGGGTCGGAACAG
GAGAGCGCACGAGGGAGCTTCCAGGGGGAAACGCCTGGTATCTTTATAG
TCCTGTCGGGTTTCGCCACCTCTGACTTGAGCGTCGATTTTTGTGATGC
TCGTCAGGGGGGCGGAGCCTATGGAAAAACGCCAGCAACGCGGCCTTTT
TACGGTTCCTGGCCTTTTGCTGGCCTTTTGCTCACATGTTCTTTCCTGC
GTTATCCCCTGATTCTGTGGATAACCGTATTACCGCCTTTGAGTGAGCT
GATACCGCTCGCCGCAGCCGAACGACCGAGCGCAGCGAGTCAGTGAGCG
AGGAAGCGGAAGAGCGCCTGATGCGGTATTTTCTCCTTACGCATCTGTG
CGGTATTTCACACCGCATATATGGTGCACTCTCAGTACAATCTGCTCTG
ATGCCGCATAGTTAAGCCAGTATACACTCCGCTATCGCTACGTGACTGG
GTCATGGCTGCGCCCCGACACCCGCCAACACCCGCTGACGCGCCCTGAC
GGGCTTGTCTGCTCCCGGCATCCGCTTACAGACAAGCTGTGACCGTCTC
CGGGAGCTGCATGTGTCAGAGGTTTTCACCGTCATCACCGAAACGCGCG
AGGCAGCTGCGGTAAAGCTCATCAGCGTGGTCGTGAAGCGATTCACAGA
TGTCTGCCTGTTCATCCGCGTCCAGCTCGTTGAGTTTCTCCAGAAGCGT
TAATGTCTGGCTTCTGATAAAGCGGGCCATGTTAAGGGCGGTTTTTTCC
TGTTTGGTCACTGATGCCTCCGTGTAAGGGGGATTTCTGTTCATGGGGG
TAATGATACCGATGAAACGAGAGAGGATGCTCACGATACGGGTTACTGA
TGATGAACATGCCCGGTTACTGGAACGTTGTGAGGGTAAACAACTGGCG
GTATGGATGCGGCGGGACCAGAGAAAAATCACTCAGGGTCAATGCCAGC
GCTTCGTTAATACAGATGTAGGTGTTCCACAGGGTAGCCAGCAGCATCC
TGCGATGCAGATCCGGAACATAATGGTGCAGGGCGCTGACTTCCGCGTT
TCCAGACTTTACGAAACACGGAAACCGAAGACCATTCATGTTGTTGCTC
AGGTCGCAGACGTTTTGCAGCAGCAGTCGCTTCACGTTCGCTCGCGTAT
CGGTGATTCATTCTGCTAACCAGTAAGGCAACCCCGCCAGCCTAGCCGG
GTCCTCAACGACAGGAGCACGATCATGCGCACCCGTGGGGCCGCCATGC
CGGCGATAATGGCCTGCTTCTCGCCGAAACGTTTGGTGGCGGGACCAGT
GACGAAGGCTTGAGCGAGGGCGTGCAAGATTCCGAATACCGCAAGCGAC
AGGCCGATCATCGTCGCGCTCCAGCGAAAGCGGTCCTCGCCGAAAATGA
CCCAGAGCGCTGCCGGCACCTGTCCTACGAGTTGCATGATAAAGAAGAC
AGTCATAAGTGCGGCGACGATAGTCATGCCCCGCGCCCACCGGAAGGAG
CTGACTGGGTTGAAGGCTCTCAAGGGCATCGGTCGAGATCCCGGTGCCT
AATGAGTGAGCTAACTTACATTAATTGCGTTGCGCTCACTGCCCGCTTT
CCAGTCGGGAAACCTGTCGTGCCAGCTGCATTAATGAATCGGCCAACGC
GCGGGGAGAGGCGGTTTGCGTATTGGGCGCCAGGGTGGTTTTTCTTTTC
ACCAGTGAGACGGGCAACAGCTGATTGCCCTTCACCGCCTGGCCCTGAG
AGAGTTGCAGCAAGCGGTCCACGCTGGTTTGCCCCAGCAGGCGAAAATC
CTGTTTGATGGTGGTTAACGGCGGGATATAACATGAGCTGTCTTCGGTA
TCGTCGTATCCCACTACCGAGATATCCGCACCAACGCGCAGCCCGGACT
CGGTAATGGCGCGCATTGCGCCCAGCGCCATCTGATCGTTGGCAACCAG
CATCGCAGTGGGAACGATGCCCTCATTCAGCATTTGCATGGTTTGTTGA
AAACCGGACATGGCACTCCAGTCGCCTTCCCGTTCCGCTATCGGCTGAA
TTTGATTGCGAGTGAGATATTTATGCCAGCCAGCCAGACGCAGACGCGC
CGAGACAGAACTTAATGGGCCCGCTAACAGCGCGATTTGCTGGTGACCC
AATGCGACCAGATGCTCCACGCCCAGTCGCGTACCGTCTTCATGGGAGA
AAATAATACTGTTGATGGGTGTCTGGTCAGAGACATCAAGAAATAACGC
CGGAACATTAGTGCAGGCAGCTTCCACAGCAATGGCATCCTGGTCATCC
AGCGGATAGTTAATGATCAGCCCACTGACGCGTTGCGCGAGAAGATTGT
GCACCGCCGCTTTACAGGCTTCGACGCCGCTTCGTTCTACCATCGACAC
CACCACGCTGGCACCCAGTTGATCGGCGCGAGATTTAATCGCCGCGACA
ATTTGCGACGGCGCGTGCAGGGCCAGACTGGAGGTGGCAACGCCAATCA
GCAACGACTGTTTGCCCGCCAGTTGTTGTGCCACGCGGTTGGGAATGTA
ATTCAGCTCCGCCATCGCCGCTTCCACTTTTTCCCGCGTTTTCGCAGAA
ACGTGGCTGGCCTGGTTCACCACGCGGGAAACGGTCTGATAAGAGACAC
CGGCATACTCTGCGACATCGTATAACGTTACTGGTTTCACATTCACCAC
CCTGAATTGACTCTCTTCCGGGCGCTATCATGCCATACCGCGAAAGGTT
TTGCGCCATTCGATGGTGTCCGGGATCTCGACGCTCTCCCTTATGCGAC
TCCTGCATTAGGAAGCAGCCCAGTAGTAGGTTGAGGCCGTTGAGCACCG
CCGCCGCAAGGAATGGTGCATGCAAGGAGATGGCGCCCAACAGTCCCCC
GGCCACGGGGCCTGCCACCATACCCACGCCGAAACAAGCGCTCATGAGC
CCGAAGTGGCGAGCCCGATCTTCCCCATCGGTGATGTCGGCGATATAGG
CGCCAGCAACCGCACCTGTGGCGCCGGTGATGCCGGCCACGATGCGTCC
GGCGTAGAGGATCGAGATCTCGATCCCGCGAAATTAATACGACTCACTA
TAGGGGAATTGTGAGCGGATAACAATTCCCCTCTAGAAATAATTTTGTT
TAACTTTAAGAAGGAGATATACATATGTGTTAACTGAGTAGGATCCCAT
CACCATCACCATCACTAACTCGAGCACCACCACCACCACCACTGAGATC
CGGCTGCTAACAAAGCCCGAAAGGAAGCTGAGTTGGCTGCTGCCACCGC
TGAGCAATAACTAGCATAACCCCTTGGGGCCTCTAAACGGGTCTTGAGG
GGTTTTTTGCTGAAAGGAGGAACTATATCCGGAT

What is claimed is:

1. A vector for selecting polynucleotide open reading frames that do not contain internal ribosome binding site(s), comprising in 5′ to 3′ orientation:
(a) a promoter sequence which does not have a operational Shine-Delgarno sequence;
(b) a cloning site for the insertion of a DNA fragment, which cloning site is operatively linked to the promoter sequence;
(c) a translational coupler sequence, which translational coupler sequence comprises a stop codon and a start codon; and,
(d) a negative selection gene which (i) encodes a negative selection gene product that is toxic to a host cell in which it is expressed, and (ii) is in frame with the start codon of said translational coupler sequence.

2. The vector of claim 1, further comprising a spacer sequence oriented between the inserted DNA fragment and in-frame with the stop codon of the translational coupler sequence.

3. The vector of claim 1 or 2, which is a plasmid capable of replication in a suitable bacterial host cell.

4. The vector of claim 3, wherein the negative selection gene is the Bacillus subtillis levansucrose gene (SacB).

5. The vector of claim 3, wherein the negative selection gene is the CcdB gyrase toxin gene.

6. The vector of claim 4, which contains an operative construct comprising SEQ ID NO: 13.

7. The vector of claim 5, which contains an operative construct comprising SEQ ID NO: 14.

8. A vector for selecting polynucleotide open reading frames that do not contain a stop codon, comprising in 5′ to 3′ orientation:
(a) a promoter sequence which includes an operational Shine-Delgarno sequence;
(b) a cloning site for the insertion of a DNA fragment, which cloning site is operatively linked to the promoter sequence;
(c) a translational coupler sequence, which translational coupler sequence comprises a stop codon and a start codon; and,
(d) a selectable marker gene which encodes a positive selection gene product which is in-frame with the start codon of said translational coupler sequence.

9. The vector of claim 8, further comprising a spacer sequence oriented between the inserted DNA fragment and in-frame with the stop codon of the translational coupler sequence.

10. The vector of claim 8 or 9, which is a plasmid capable of replication in a suitable bacterial host cell.

11. The vector of claim 10, wherein the selectable marker gene is a bacterial survival gene.

12. The vector of claim 11, wherein the selectable marker gene is a dihydrofolate reductase gene.

13. The vector of claim 12, wherein the dihydrofolate reductase gene has the sequence of SEQ ID NO: 3.

14. The vector of claim 10, which contains an operative construct comprising SEQ ID NO: 15.

15. A method for selecting polynucleotide fragments containing open reading frames which do not contain an internal ribosome binding site or a stop codon, from a library of fragments, comprising:
(a) cloning the library of fragments into the cloning site of a first vector according to claim 6 or 7;
(b) transforming bacteria with the first vector containing the library of fragments and culturing the transformed bacteria under conditions which permit the negative selection gene product encoded by the first vector to kill bacteria in which it is expressed, in order to select for a first sub-set of surviving bacteria containing a first sub-set of polynucleotide fragments which do not encode an internal ribosome binding site;
(c) preparing plasmids from the first sub-set of surviving bacteria and isolating the first sub-set of polynucleotide fragments therefrom;
(d) cloning the first sub-set of polynucleotide fragments into the cloning site of a second vector according to claim 14;
(e) transforming bacteria with the second vector containing the library of the first sub-set of polynucleotide fragments and culturing the transformed bacteria under conditions which permit the selectable marker encoded by the second vector to function, in order to select for a second sub-set of surviving bacteria containing a second sub-set of polynucleotide fragments which do not encode a stop codon,
thereby resulting in a final set of polynucleotide fragments that do not contain internal ribosome binding sites or stop codons.
